(19) United States
(12) Patent Application Publication
(10) Pub. No.: US 2006/0044501 A1
(43) Pub. Date: Mar. 2, 2006

(54) Vertical alignment active matrix liquid crystal display device

(75) Inventor: Ryota Mizusako, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 11/214,510

(22) Filed: Aug. 30, 2005

(30) Foreign Application Priority Data
Aug. 31, 2004 (JP) 2004-251696

(51) Int. Cl. G02F 1/1337

(52) U.S. Cl. 349/123

(57) ABSTRACT

In a liquid crystal display device, a liquid crystal with the negative dielectric anisotropy filled between a TFT substrate and a CF substrate, and the TFT substrate has a pixel electrode and an auxiliary electrode formed around the pixel electrode. The pixel electrode is a transparent electrode comprising an ITO layer, and has a slit formed from the center portion of each pixel toward the periphery portion thereof, for segmenting a pixel region into a plurality of sub-pixel regions. A recess portion for forming the center of the alignment of liquid crystal molecules is formed on the center of each segmented sub-pixel region. The liquid crystal of the sub-pixel region is aligned toward the center of the sub-pixel region by a horizontal electric filed applied between the pixel electrode and the auxiliary electrode, and, an oblique electric field generated at the edge of the slit.

### BACKGROUND OF THE INVENTION

1. Field of the Invention

The present invention relates to a vertical alignment active matrix liquid crystal display device which initially aligns the liquid crystal molecules substantially perpendicular to a substrate surface.

2. Description of the Related Art

A conventional TFT (Thin Film Transistor) liquid crystal panel comprises a TFT substrate on which TFTs, pixel electrodes, and the like are formed, a CF (Color Filter) substrate on which CFs, an opposing electrode, and the like are formed, and a liquid crystal layer which is sandwiched between the TFT substrate and the CF substrate. A liquid crystal material with the positive dielectric anisotropy is generally used in a TFT liquid crystal panel which aligns the liquid crystal molecules homogeneously, like a TN (Twisted Nematic) liquid crystal display. A material with the negative dielectric anisotropy is used in a liquid crystal display panel which aligns the liquid crystal molecules homeotropically and aligns the director (molecular long axis direction) toward the direction perpendicular to the substrate in no electric field (initial alignment).

In the vertical alignment TFT liquid crystal display device which homeotropically aligns the liquid crystal molecules in the initial alignment, a vertical alignment film is formed on each of the opposing inner surfaces, and a liquid crystal with the negative dielectric anisotropy is filled between a pair of glass substrates which are arranged opposite to each other, thereby constituting a liquid crystal cell.

In the liquid crystal cell, pixel electrodes are formed, pixel by pixel, on one of the pair of substrates, and a common (opposing) electrode which faces the pixel electrodes is formed on the other substrate. One pixel is formed by each pixel electrode, the opposing portion of the common electrode, and the liquid crystal therebetween. A vertical alignment film, on which a rubbing process (aligning treatment) is performed to define a direction in which the liquid crystal molecules lean when a voltage is applied between the pixel electrode and the opposing electrode, is so formed on each substrate as to cover the pixel electrode and the opposing electrode.

In a case where no voltage is applied between the pixel electrode and the opposing electrode, because the opposing electrode and the pixel electrode have the same electric potential, no electric field is formed between those electrodes, and, because of the effect of the vertical alignment film, the liquid crystal molecules are vertically aligned relative to the substrate.

When a voltage is applied between the pixel electrode and the opposing electrode, the liquid crystal molecules behave to incline because of the electric field formed between those electrodes. When a sufficiently high voltage is applied between those electrodes, the liquid crystal molecules are aligned substantially homogeneous with the substrate. In this case, the liquid crystal molecules are aligned along one direction in the rubbing direction of the vertical alignment film, thereby resulting in a large view angle dependency of the contrast and a poor view angle characteristic.

To obtain the wide view angle characteristic in the vertical alignment liquid crystal display apparatus, it is proposed to form a plurality of domains where the liquid crystal molecules are aligned along plural directions pixel by pixel. For instance, as described in the specification of Japanese Patent Publication No. 2565639, a liquid crystal display apparatus proposed has the opposing electrode formed with an aperture with the shape of a letter X, and, the liquid crystal molecules in each pixel are so aligned as to tilt toward the center of the X-shaped aperture along the four directions when a voltage is applied between the pixel electrode and the common electrode laid out opposite to each other.

In this liquid crystal display apparatus, the opposing electrode is formed larger than the pixel electrode, and, when a voltage is applied between the pixel electrode and the opposing electrode, a vertical electric field is generated at that portion of the pixel region where the pixel electrode is opposite to the opposing electrode, an oblique electric field is generated at the peripheral portion of the pixel electrode, and a discontinuous electric field is generated at that portion of the opposing electrode where the slit is formed. As a result, the liquid crystal molecules are so aligned as to tilt toward the center of the X-shaped aperture. That is, in this liquid crystal display apparatus, the liquid crystal molecules are so aligned as to incline along the four directions for each pixel and for each region defined by the X-shaped aperture.

According to the above-described liquid crystal display apparatus, however, because the X-shaped aperture formed in each pixel forms regions with different alignment directions, the X-shaped aperture should be formed wide enough to prevent the interaction between the regions. Accordingly, in each pixel, the area of the aperture (slit) which is not controllable by the electric field becomes large, and the area of the opposing electrode becomes small, resulting in a low aperture ratio.

In U.S. patent application Ser. No. 11/182,233 filed Jul. 15, 2005, which was filed by the same applicant, a liquid crystal display device has been proposed in which a pixel region is segmented into a plurality of sub-pixel regions by an auxiliary electrode formed on the periphery of a pixel electrode, and a slit formed in the pixel electrode, to align the liquid crystal molecules of each sub-pixel region in a predetermined state.

The stability of the alignment in each sub-pixel region is, however, yet insufficient.

### SUMMARY OF THE INVENTION

An object of the invention is to provide a liquid crystal display device with a less defective display, a wide view angle, and a high transmittance.

To achieve the object, a liquid crystal display device according to the first aspect of the invention is a liquid crystal display device which comprises:

a first substrate provided with a first electrode;

a second substrate which is provided with at least one second electrode arranged opposite to the first electrode with a predetermined gap therebetween, and forms individual pixel regions by that region which faces the first electrode;

an auxiliary electrode formed on that surface of the second substrate on which the second electrode is provided, along at least a periphery of the pixel region;

a vertical alignment film formed on each of opposing inner surfaces of the first electrode and the second electrode;

a liquid crystal layer with a negative dielectric anisotropy filled between the substrates, wherein:

at least one of the first electrode and the second electrode is provided with an aperture for segmenting that pixel region into a plurality of sub-pixel regions for each pixel region; and

a step portion which aligns liquid crystal molecules of the liquid crystal layer in accordance with a shape of a film surface of the vertical alignment film, and is formed on at least any one of a substantial center portion of each sub-pixel region, a corner portion of each segmented neighboring sub-pixel region, and a periphery portion of the pixel region of either the first substrate or the second substrate.

In such a liquid crystal display device according to the first aspect, the second electrode is formed with the aperture to segment the pixel region into the plurality of sub-pixel region, and, the step portion for aligning the liquid crystal molecules of the liquid crystal layer in accordance with the shape of the film surface of the vertical alignment film, is formed on any one of the substantial center portion of each sub-pixel region, the corner portion of each segmented neighboring sub-pixel region, and the periphery portion of the pixel region. Accordingly, the center of the alignment of the liquid crystal molecules is defined for each sub-pixel region, and the alignment of the liquid crystal molecules at each sub-pixel region is stabilized. This results in the resolution of the display roughness and unevenness. As the liquid crystal molecules are radially aligned from the center of each sub-pixel region for each sub-pixel region, the view angle characteristic is improved.

In the liquid crystal display device of the invention, it is desirable that the step portion should be formed on the center portion of each sub-pixel region, and, in this case, it is preferable that the step portion should be a recess portion.

It is desirable that the step portion should be formed in between the neighboring sub-pixel regions, and, in this case, it is preferable that the step portion should be a protrusion, and, it is desirable that the step portion should be formed on the corner portion of the sub-pixel region for each sub-pixel region.

The step portions may be formed on the substantial center portion of each sub-pixel region and the periphery portion of the pixel region. In this case, it is preferable that the step portion should comprise a recess portion which is formed on the center portion of the sub-pixel region, and a protrusion which forms a step in such a way that the circumference of the pixel region is higher than the pixel region.

A liquid crystal display device according to the second aspect of the invention is a liquid crystal display device which comprises:

a first substrate provided with a first electrode;

a second substrate provided with at least one second electrode arranged opposite to the first electrode with a predetermined gap therebetween, and forms individual pixel regions by that region which faces the first electrode;

an auxiliary electrode formed on that surface of the second substrate on which the second electrode is provided, along at least a periphery of the pixel region;

a vertical alignment film formed on each of opposing inner surfaces of the first electrode and the second electrode;

a liquid crystal layer with a negative dielectric anisotropy filled between the substrates;

a slit provided on at least the second electrode in the first and the second electrode for segmenting the pixel region into a plurality of sub-pixel regions, and for aligning a molecular long axis of liquid crystal molecules of the liquid crystal layer from a periphery to a center for individual pixel regions, by an electric field applied between the second electrode and the auxiliary electrode; and

an alignment definition unit which forms a center or a base point of an alignment of the liquid crystal molecules of the liquid crystal layer on at least any one of a substantial center portion of each segmented sub-pixel region, a corner portion of each segmented neighboring sub-pixel region, or a periphery portion of the pixel region of that surface of the second electrode on which the second electrode is provided.

In such a liquid crystal display device according to the second aspect, the second electrode is formed with the slit extending from the center of the pixel to the periphery to segment the pixel region into the plurality of sub-pixel region, and, for each segmented sub-pixel region, the alignment definition unit for forming the center or the base point of the alignment of the liquid crystal molecules of the liquid crystal layer is formed on any one of the substantial center portion of each segmented sub-pixel region, the corner portion of each segmented neighboring sub-pixel region, or the periphery portion of the pixel region. Accordingly, the center of the alignment of the liquid crystal molecules is defined for each sub-pixel region. Therefore, the alignment of the liquid crystal molecules at each sub-pixel region is stabilize. This results in the resolution of the display roughness and unevenness. As the liquid crystal molecules are radially aligned from the center of each sub-pixel region for each sub-pixel region, the view angle characteristic is improved.

In the liquid crystal display device, it is preferable that the alignment definition unit should comprise a recess portion or a protrusion which is formed on the substantial center portion of each sub-pixel region or in between the neighboring sub-pixel regions. In this case, the alignment definition unit may be a recess portion formed on the substantial center portion of each sub-pixel region, or, the alignment definition unit may be a protrusion which is formed on the corner portion of the sub-pixel region in between the neighboring sub-pixel regions. It is further preferable that the alignment definition should section comprise a recess portion which is formed on the substantial center portion of each sub-pixel region, and a protrusion which is formed in between the neighboring sub-pixel regions.

The alignment definition unit may be steps which are formed on the substantial center portion of each sub-pixel region and the periphery portion of the pixel region, and, those alignment definition units may be a recess portion which is formed on the substantial center portion of each sub-pixel region, and a protrusion which forms a step in such a way that the periphery portion of the pixel region is higher than the pixel region.

It is preferable that the slit in the liquid crystal display device should comprise a plurality of notches which are formed in such a manner as to extend from a center of each pixel region to a periphery thereof, and be connected to one another at a center portion of the pixel region.

It is desirable that the auxiliary electrode should be set to an electric potential equal to an electric potential of the first electrode opposite to the second electrode, and, it is preferable that the auxiliary electrode should comprise a compensating-capacitor electrode which overlaps a periphery portion of the second electrode, and forms a compensating capacitor between the second electrode and the compensating-capacitor electrode.

A liquid crystal display device according to the third aspect of the invention is a liquid crystal display device which comprises:

a first substrate provided with a first electrode;

a second substrate provided with at least one second electrode arranged opposite to the first electrode with a predetermined gap therebetween, and forms individual pixel regions by that region which faces the first electrode;

a first auxiliary electrode formed on that surface of the second substrate on which the second electrode is provided, along at least a periphery of the pixel region;

a vertical alignment film formed on each of opposing inner surfaces of the first electrode and the second electrode;

a liquid crystal layer with a negative dielectric anisotropy filled between the substrates;

a slit provided on at least either the first electrode or the second electrode for segmenting the pixel region into a plurality of sub-pixel regions, and for aligning a molecular long axis of liquid crystal molecules of the liquid crystal layer from a periphery to a center for individual pixel regions, by an electric field applied between the second electrode and the auxiliary electrode; and

a second auxiliary electrode which is placed at a corner portion of each sub-pixel region between the segmented individual subpixel regions of that surface of the second substrate on which the second electrode is provided, and so formed as to be isolated from the second electrode.

In such a liquid crystal display device according to the third aspect, the second electrode is formed with the slit extending from the center of the pixel to the periphery to segment the pixel region into the plurality of sub-pixel region, and, the second auxiliary electrode is placed at the corner portion of each sub-pixel region between the segmented individual sub-pixel regions and so formed as to be isolated from the second electrode. Accordingly, the center of the alignment of the liquid crystal molecules is defined for each sub-pixel region, and the alignment of the liquid crystal molecules at each sub-pixel region is stabilized. This results in the resolution of the display roughness and unevenness. As the liquid crystal molecules are radially aligned from the center of each sub-pixel region for each sub-pixel region, the view angle characteristic is improved.

In the liquid crystal display device, it is preferable that the second auxiliary electrode should be connected to the first auxiliary electrode. It is preferable that the second auxiliary electrode should comprise a transparent conductive film.

### BRIEF DESCRIPTION OF THE DRAWINGS

These objects and other objects and advantages of the present invention will become more apparent upon reading of the following detailed description and the accompanying drawings in which:

FIG. 1 is a top plan view schematically illustrating one pixel structure of a vertical alignment liquid crystal display device according to a first embodiment of the invention;

FIG. 2 is a cross-sectional view illustrating one pixel illustrated in FIG. 1 cut along the line II-II;

FIG. 3 is an exemplary diagram illustrating the alignment of liquid crystal molecules of the liquid crystal display device of FIG. 1 in an enlarging manner,

FIG. 4 is a cross-sectional view taken along the line IV-IV in FIG. 3;

FIG. 5 a cross-sectional view taken along the line V-V in FIG. 3;

FIG. 6 is a top plan view schematically illustrating one pixel structure of a liquid crystal display device according to a second embodiment of the invention;

FIG. 7 is a cross-sectional view taken along the line VII-VII in FIG. 6;

FIG. 8 is a top plan view schematically illustrating one pixel structure of a liquid crystal display device according to a third embodiment of the invention;

FIG. 9 is a cross-sectional view taken along the line IX-IX in FIG. 8;

FIG. 10 is a top plan view schematically illustrating one pixel structure of a liquid crystal display device according to a fourth embodiment of the invention; and

FIG. 11 is a cross-sectional view taken along the line XI-XI.

### DETAILED DESCRIPTION OF THE PREFERRED EMBODIMENTS

Liquid crystal display devices will be described below as embodiments of the present invention with reference to the accompanying drawings.

### First Embodiment

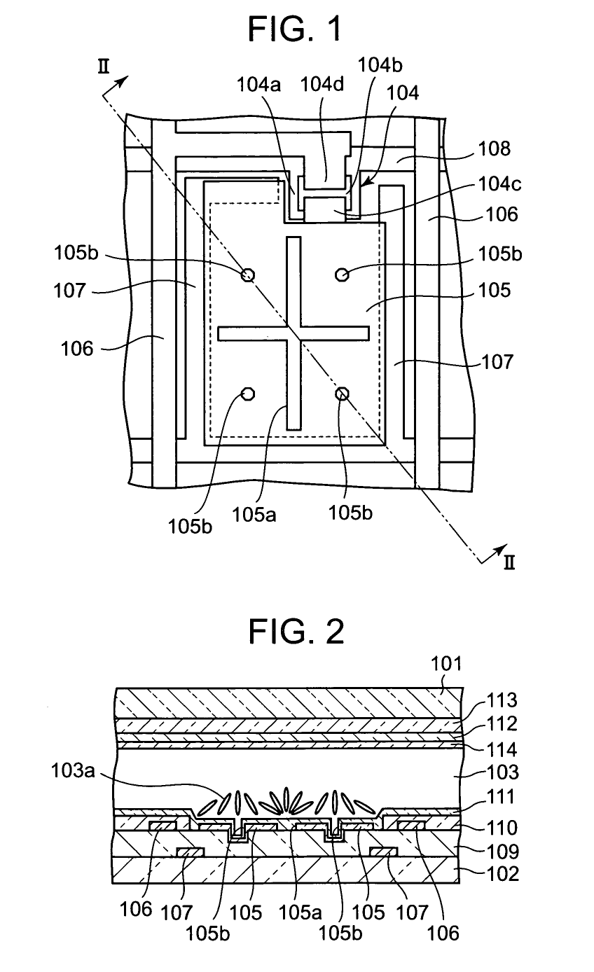

FIG. 1 is a top plan view schematically illustrating one pixel structure of a vertical alignment liquid crystal display device according to the first embodiment of the invention. FIG. 2 is a cross-sectional view illustrating one pixel illustrated in FIG. 1 cut along the line II-II.

The liquid crystal display device which constitutes the liquid crystal display apparatus comprises a pair of glass substrates 101, and 102, arranged opposite to each other. A liquid crystal 103 with the negative dielectric anisotropy is filled between one glass substrate (hereinafter called TFT substrate 102) and the other glass substrate 101 (hereinafter called opposing substrate 101).

Formed on the surface of the TFT substrate 102 opposing the opposing substrate 101 are TFT devices 104, pixel electrodes 105, drain lines 106, auxiliary electrodes 107, gate lines 108, a gate insulation film 109, an insulation film 110, and an alignment film 111. Formed on the inner surface of the opposing substrate 101 are an opposing electrode 112, a color filter 113, and an alignment film 114.

The TFT device 104 is an inversely staggered thin film transistor which is formed on the glass substrate 102. The TFT device 104 has a gate electrode 104a, a semiconductor layer 104b, a source electrode 104c, and a drain electrode 104d.

The pixel electrode 105 is formed by an approximately quadrangle transparent electrode which comprises, for instance, an ITO film essentially consisting of an indium oxide. The pixel electrode 105 defines the region of a single pixel which is the smallest unit for forming an image with that region which opposes the opposing electrode 112. A narrow aperture 105a for segmenting each pixel into a plurality of sub-pixel regions is formed in the pixel electrode 105 for each pixel. The aperture 105a comprises a plurality of slits which extend from the center of the pixel electrode 105 to the periphery thereof, and are connected to one another at the center of the pixel electrode 105 (hereinafter, the aperture is called slit).

In the embodiment, the slits 105a are formed by incising the pixel electrode 105 in such a way as to extend along the vertical and horizontal directions from the center portion of the pixel electrode 105, and segment one pixel region into four sub-pixel regions.

Formed on the substantial center of each segmented of the pixel electrode 105 is a recess portion 105b which forms the center or the base point of the alignment of liquid crystal molecules of each sub-pixel region, and is formed in a circular or a polygonal (for example, octagonal) planar shape for forming a step. The recess portion 105b is formed by boring a hole in the gate insulation film 109, and depositing the pixel electrode 105, and the alignment film 111 thereon.

The drain line 106 of the liquid crystal display panel of the embodiment comprises an aluminum line or the like which is so formed as to run along the column direction for each column of pixels. The drain line 106 is connected to the drain electrodes 104d of the TFT devices 104 in the same pixel column, and supplies the image signal from a column driver to the pixel electrode 105, via the enabled TFT devices 104.

The auxiliary electrode 107 is made of aluminum or the like, and is so formed as to partly overlap the periphery portion of the pixel electrode 105 via the gate insulation film 109. The auxiliary electrode 107 is kept at a predetermined electric potential lower than that of the pixel electrode 105, and more preferably, set at the same electric potential as that of the opposing electrode 112, and, together with the pixel electrode 105, forms the compensating capacity which is connected in parallel to a pixel capacitor, formed by each pixel electrode 105, the opposing electrode 112 and the liquid crystal 103.

The gate line 108 comprises an aluminum line or the like which is so formed as to run along the row direction for each pixel row, and electrically isolated from the other electrodes by the gate insulation film 109. The gate line 108 is connected to the gate electrodes 104a of the TFT devices 104 in the corresponding pixel row, supplies a scan signal to the ITT devices 104, and controls the ON/OFF actions of the ITT devices 104.

The gate insulation film 109 is formed on the substrate 102 on which the gate electrodes 104a of the TFT devices 104, the gate line 108, and the auxiliary electrode 107 are formed, and comprises, for instance, a silicon nitride film. The gate insulation film 109 electrically isolates the gate electrode 104a of the TFT device 104 from the semiconductor layer 104b and the source/drain electrodes 104c, and 104d which are opposite to that gate electrode 104a. The source electrode 104c of the TFT device 104 is connected to the corresponding pixel electrode 105, and the drain electrode 104d of the IFT device 104 is connected to the corresponding drain line 106.

The insulation film 110, which covers the drain line 106, is formed between the pixel electrode 105 and that of the neighboring pixel electrode 105, and comprises, for instance, a silicon nitride film. The insulation film 110 provides a step portion where the periphery of the pixel region is higher than the pixel region, and, the step portion forms an inclined portion.

Each of the alignment films 111, and 114 comprises hexamethyldisiloxane-polymerization film or the like which is formed by, for example, CVD (Chemical VaporDeposition). The alignment films 111, and 114 are so formed as to respectively cover the pixel electrode 105 and the opposing electrode 112. The liquid crystal 103 is filled between those alignment films 111, and 114. The alignment films 111, and 114 are not rubbed, and allow the liquid crystal molecules in the vicinities of their surfaces to be vertically aligned relative to the alignment film surface when no electric field is formed.

Next, the method for manufacturing the liquid crystal display device structured as stated will be explained.

An aluminum film is formed on the one glass substrate 102, and patterned to form the gate electrodes 104a of the TFT devices 104, the gate lines 108, and the auxiliary electrodes 107 (including the lines which mutually connect the auxiliary electrodes 107). Next, the gate insulation film 109 is formed by CVD. Subsequently, channel layers (semiconductor layers), the source and drain layers, etc. of the TFT devices 104 are formed on the gate insulation film 109.

Predetermined portions of the gate insulation film 109 are etched to form openings, and an ITO film is formed on the gate insulation film 109 in which the openings are formed, by sputtering. The ITO film is etched and patterned, excluding that portion of the ITO film which constitutes the pixel region, yielding the pixel electrodes 105 each formed with the narrow slits 105a cut away extending toward the peripheral portion of the pixel region from the central portion thereof, and the recess portions 105b formed in the centers of the respective sub-pixel regions.

The drain lines 106 are formed on the gate insulation film 109, apart from the peripheries of the pixel electrodes 105, and are connected to the drain electrodes 104d of the TFT devices 104. The insulation film 110 is formed on the gate insulation film 109 in such a manner as to cover the drain lines 106 formed on non-pixel regions around the pixel electrodes 105.

Subsequently, the alignment film 111 is formed on the entire surface of the substrate by CVD, spin coating, or the like.

The TFT substrate 102 thus formed and the opposing substrate 101 on which the opposing electrode 112, the color filter 113, etc. are formed, are arranged opposite to each other with a non-illustrated spacer sandwiched therebetween, and their peripheries are sealed by a seal material, thereby forming each liquid crystal cell. Next, the liquid crystal with the negative dielectric anisotropy is filled in the liquid crystal cell, and a liquid-crystal inlet is sealed. Non-illustrated polarizing plates are placed on the outer surfaces of the TFT substrate 102 and the opposing substrate 101, thereby fabricating the liquid crystal display device.

Next, the behavior of the liquid crystal molecules in the pixel with the above-described structure will be explained.

One pixel region is defined by a region where one pixel electrode 105 and the opposing electrode 112 face each other, and segmented into four of the sub-pixel regions by the plural slits 105a formed on the pixel electrode 105. The periphery of one sub-pixel region is surrounded by the auxiliary electrode 107, and, when a voltage is applied between the pixel electrode 105 and the auxiliary electrode 107, horizontal electric fields are generated at around each pixel region. Oblique electric fields are generated at the edges of the slits 105a of the pixel electrode 105.

The step portion which is formed on the periphery portion of each pixel region forms the inclined surface on the alignment film surface, and the liquid crystal molecules 103 are aligned perpendicular to that inclined surface.

Because the substantially inclined surface is formed on the recess portion 105b, formed on the pixel electrode 105, by the step of the recess portion 105b, the liquid crystal molecules near the recess portion 105b are so aligned as to tilt toward the center of the recess portion 105b, so that the center of the alignment is defined.

Accordingly, when a voltage is applied between the pixel electrode 105 and the opposing electrode 112, the liquid crystal molecules 103a start tilting toward the center of each sub-pixel region from the periphery thereof for each sub-pixel region, as illustrated in FIG. 2, because of the inclined surface of the alignment film on the periphery of the pixel, the horizontal electric fields around the pixel electrode 105, and the oblique electric fields at the edges of the slits 105a. When a sufficiently high voltage is applied between the pixel electrode 105 and the opposing electrode 112, the liquid crystal molecules 103a are radially aligned toward the center of each sub-pixel region from the periphery thereof as the center of the alignment of the liquid crystal molecules is defined at the center of each sub-pixel region by the recess portion 105. In this case, because the liquid crystal molecules 103 at the center of each sub-pixel region receive intermolecular forces from the liquid crystal molecules 103a at the periphery tilting toward the center, the liquid crystal molecules 103 are aligned perpendicular to the substrate surface.

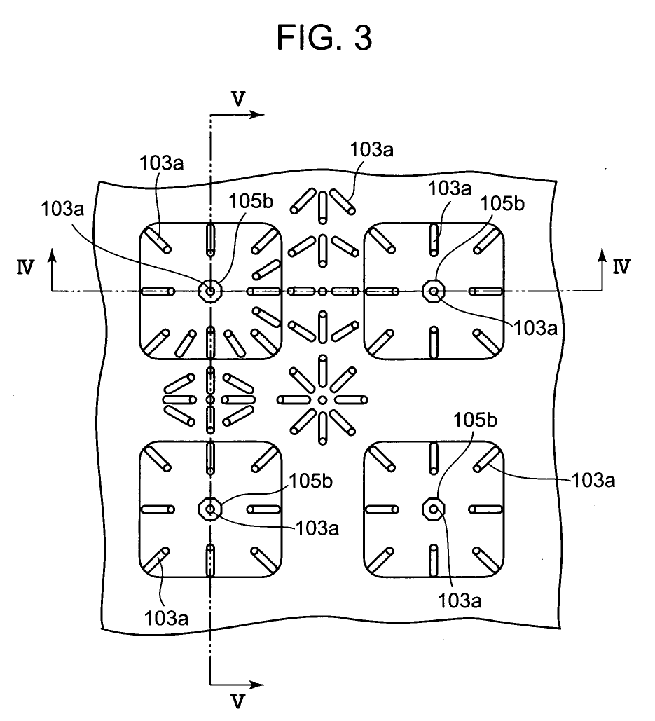

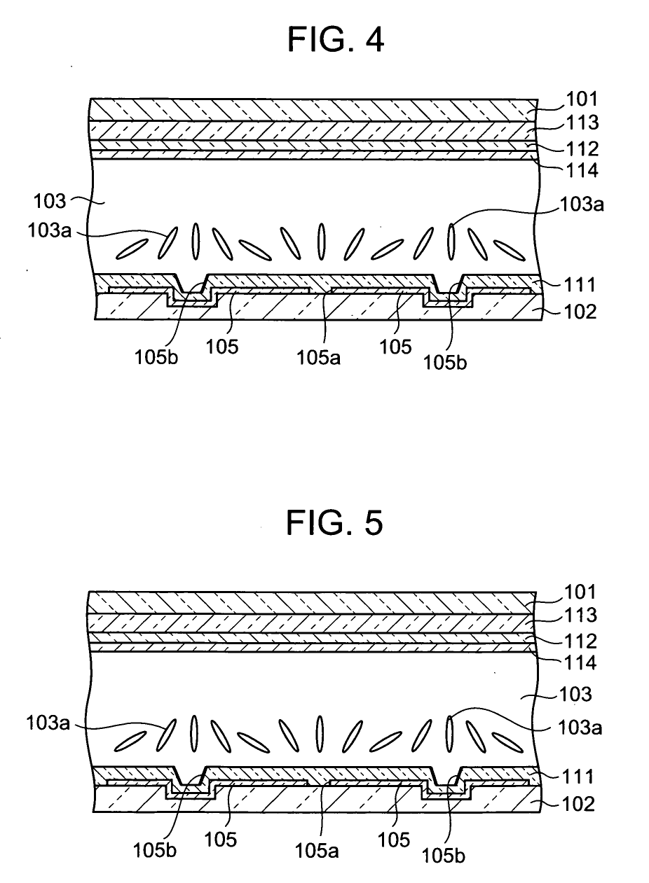

FIG. 3 illustrates the alignment of the liquid crystal molecules of one pixel region in an enlarging manner. FIG. 4 illustrates that alignment at the cross section taken along the line IV-IV. FIG. 5 illustrates that alignment at the cross section taken along the line V-V As illustrated in FIGS. 3 to 5, the liquid crystal molecules 103a are aligned in such a way that the long axis directions (directors) thereof tilt toward the center of the recess portion 105b, with that center being as the base point. In contrast, the liquid crystal molecules 103a at the center of each sub-pixel region equally receive the intermolecular forces from the liquid crystal molecules at the periphery tilting toward the center, and are thus aligned perpendicular to the substrate surface.

As mentioned above, in viewing each sub-pixel region, the liquid crystal molecules 103a at the slits of the pixel electrodes 105 are aligned with the directors being approximately perpendicular to the substrate surface by the slits of the pixel electrode 105. The liquid crystal molecules 103a are aligned in such a way that the directors become oblique as the locations of the directors go inward from the periphery of the pixel region and the edges of the slits 105a, and the directors faces in the direction perpendicular to the substrate at the center of each sub-pixel region.

As described above, the slits 105a extending toward the periphery of the pixel from the center of the pixel region are formed on the pixel electrode 105 to segment the pixel region into the plurality of sub-pixel regions. The recess portion 105b is formed in the pixel electrode 105 at the center of the pixel region for each segmented sub-pixel region. At the periphery portion of each segmented sub-pixel region, the liquid crystal molecules are aligned toward the center of the sub-pixel region from the periphery thereof, for each divided sub-pixel region, due to the electric fields generated by the voltage applied between the pixel electrode 105 and the auxiliary electrode 107, and the electric fields generated at the edges of the slits 105a. The recess portion 105b formed on the center of each sub-pixel region defines the center of the alignment of the liquid crystal molecules 103a for each sub-pixel region, thereby stabilizing that alignment. This results in the resolution of the display roughness and unevenness. As the liquid crystal molecules are radially aligned from the center of each sub-pixel region for each sub-pixel region, the view angle characteristic is improved.

### Second Embodiment

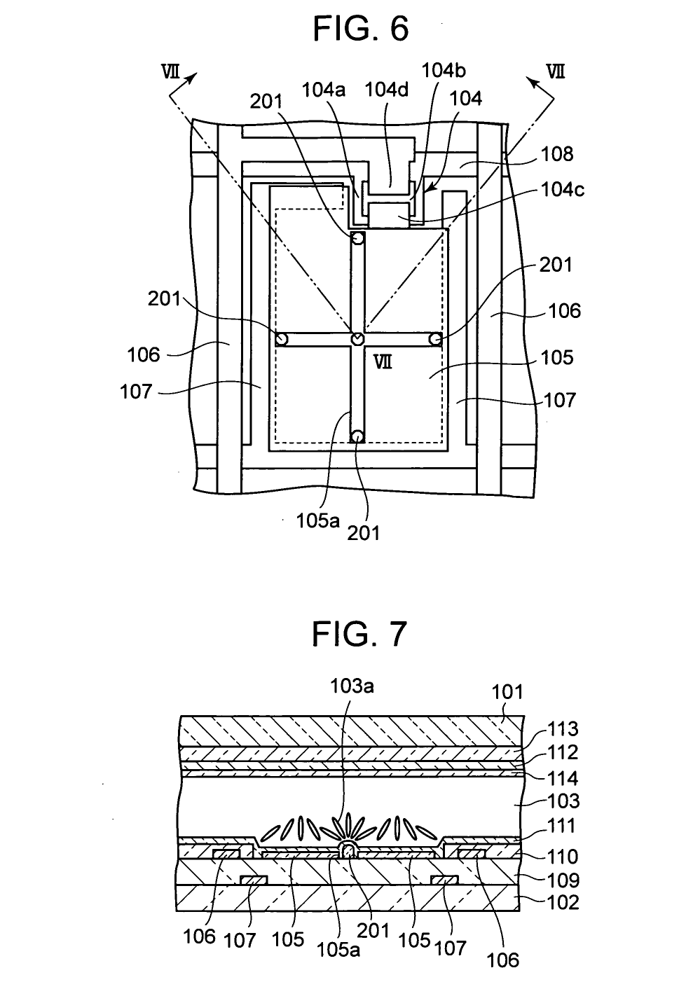

Next, the second embodiment of the invention will be described with reference to FIGS. 6 and 7.

FIG. 6 illustrates a schematic planar structure of one pixel of a liquid crystal display device according to the embodiment FIG. 7 illustrates a cross section taken along the line VII-VII in FIG. 6.

In FIG. 6, formed on the inner surface of the TFT substrate 102 are the TFT devices 104, the pixel electrodes 105, the drain lines 106, the auxiliary electrodes 107, the gate lines 108, the gate insulation film 109, the insulation film 110, and the alignment film 111. In the embodiment, the same structure portions as those of the first embodiment will be denoted by the same reference numbers to avoid repeating otherwise their redundant descriptions.

The pixel electrode 105 is formed by an approximately quadrangle transparent electrode which comprises, for instance, an ITO film essentially consisting of an indium oxide. The slits 105a are so formed as to extend along the vertical and horizontal directions at the center portion of the pixel electrode 105. Protruding portions for forming the centers or the base points of the alignment of the liquid crystal molecules of each sub-pixel region and for providing steps are formed on a portion where the slits 105a intersect one another, and the ends of those slits 105a, by dielectric protrusions 201.

The protrusion 201 is formed between the sub-pixel regions each segmented by the slit 105a (inside the slit 105a), and formed in a circular or a polygonal (for example, octagonal) planar shape. That is, the protrusion 201 is placed at the corner portion of each segmented sub-pixel region as illustrated in FIG. 6.

Next, the method for manufacturing the liquid crystal display device structured as stated will be explained.

The gate electrodes 104a of the TFT devices 104, the gate lines 108, and the auxiliary electrodes 107 (including the lines which mutually connect the auxiliary electrodes 107) are formed on the one glass substrate 102 as per the first embodiment, and the gate insulation film 109 is formed. Subsequently, the semiconductor layers 104b of the TFT devices 104, the source electrodes 104c, the drain electrodes 104d, and the like are formed on the gate insulation film 109.

Next, an ITO film is formed on the gate insulation film 109 by sputtering. The ITO film is etched and patterned, excluding those portions of the ITO film which constitute the pixel electrodes 105, yielding the pixel electrodes 105 each formed with the narrow slits 105a cut away extending toward the peripheral portion of the pixel region from the central portion thereof in an incising manner.

The drain lines 106 are so formed on the gate insulation film 109 as to be connected to the drain electrodes 104d of the TFT devices 104 as per the first embodiment. The deposited dielectric film is patterned in such a manner as to cover the drain lines 106 formed on the non-pixel regions around the pixel electrodes 105, and form the protrusions 201 on the intersection portion of the slits, and the ends of those slits to form the insulation film 110 on the gate insulation film 109. Subsequently, the alignment film 111 is formed in the same fashion as done in the first embodiment.

Next, the behavior of the liquid crystal in the pixel with the above-described structure will be explained.

When a voltage is applied between the pixel electrode 105 and the opposing electrode 112 in the same fashion as the first embodiment, vertical electric fields are generated at a portion in each pixel where the pixel electrode 105 faces the opposing electrode 112, and horizontal electric fields are generated between the pixel electrode 105 and the auxiliary electrode 107. Electric fields in the directions oblique relative to the edges of the slits 105 are generated at the portions of the pixel electrode 105 in which the slits 105a are formed.

Because the inclined surfaces are formed on the portions of the alignment film near the protrusions 201 from the center of that film toward the periphery thereof, the liquid crystal molecules 103a at the centers of the protrusions 201 are aligned perpendicular to the substrate, and the liquid crystal molecules 103a around the protrusions 201 are aligned radially and obliquely with the centers of the protrusions 201 being as the centers of the alignment. That is, because the protrusions 201 are placed at the corner portions of the respective sub-pixel regions, the liquid crystal molecules 103a are applied with intermolecular forces which attempt to tilt the liquid crystal molecules 103a from the corners of the respective sub-pixel regions toward the centers, by the protrusions 201.

Accordingly, as illustrated in FIG. 7, the liquid crystal molecules 103a of each sub-pixel region divided by the slits 105a of the pixel electrode 105 are aligned in such a way that the long axis directions (directors) thereof tilt toward the center of each sub-pixel region from the periphery, due to the horizontal electric field at the periphery surrounded by the auxiliary electrode 107, the oblique electric fields at the edges of the slits 105a, and the intermolecular forces obliquely aligned with the protrusions 201 being the centers.

As described above, the slits 105a extending toward the periphery of the pixel from the center of the pixel region are formed on the pixel electrode 105 to segment the pixel region into the plurality of sub-pixel regions. The protrusions 201 are formed on the intersection portion of the slits 105a and the ends of those slits 105a. At the periphery portion of each segmented sub-pixel region, the liquid crystal molecules are aligned toward the center of the sub-pixel region from the periphery thereof, for each divided sub-pixel region, due to the electric fields generated in accordance with the voltage applied between the pixel electrode 105 and the auxiliary electrode 107. Accordingly, the alignment for each divided sub-pixel region can be stabilized As the protrusions 201 are formed on the intersection portion of the slits and the ends of those slits, the central location of the alignment for each sub-pixel region can be stabilized, and, This will result in the resolution of the display roughness and unevenness. As the liquid crystal molecules are aligned toward the center of a domain at each domain, the view angle characteristic is improved.

### Third Embodiment

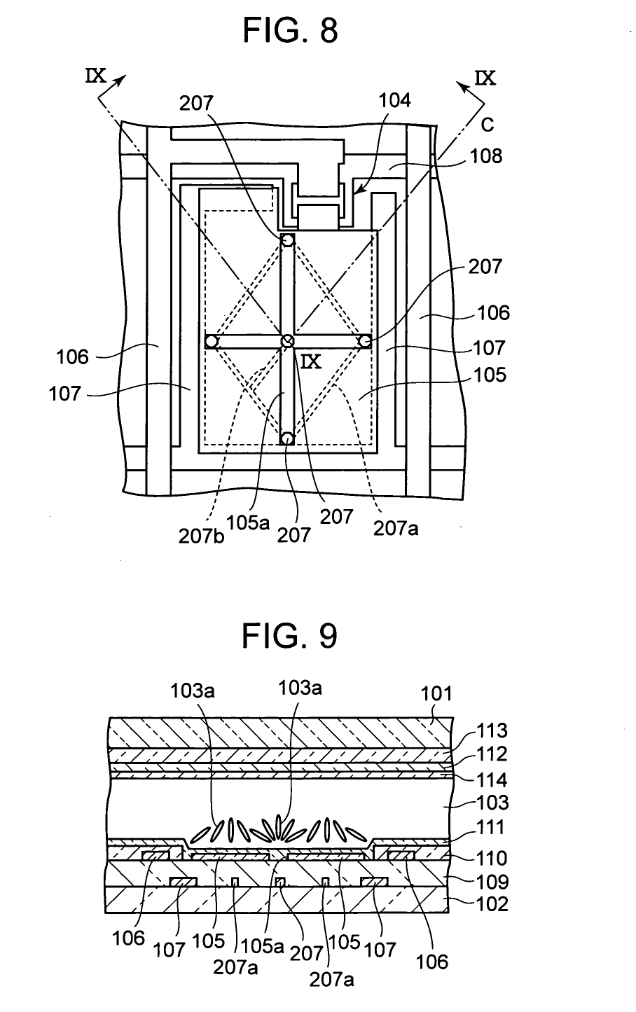

FIG. 8 is an exemplary diagram illustrating the pixel structure of a liquid crystal display device according to the third embodiment of the invention.

Formed on the inner surface of one TFT substrate 102 are the TFT devices 104, the pixel electrodes 105, the drain lines 106, the auxiliary electrodes 107, the gate lines 108, the gate insulation film 109, the insulation film 110, and the alignment film 111. In the embodiment, the same structure portions as those of the first embodiment will be denoted by the same reference numbers, and their explanations will be omitted.

The pixel electrode 105 is formed by an approximately quadrangle transparent electrode which comprises, for instance, an ITO film essentially consisting of an indium oxide. The slits 105a are so formed on the pixel electrode 105 as to extend along the vertical and horizontal directions at the center portion of the pixel electrode 105.

The first auxiliary electrode 107 is made of aluminum or the like, and is so formed as to partly overlap the periphery portion of the pixel electrode 105 via the gate insulation film 109 around the pixel electrode 105.

Second auxiliary electrodes 207 for forming the center or the base point of the alignment of the liquid crystal molecules of each sub-pixel region are formed on portions corresponding to the intersection portion of the slits 105a of the pixel electrode 105 and the ends of those slits.

The second auxiliary electrodes 207 are formed underneath the portions of the pixel electrode 105 on the portions corresponding to the slits 105a. Each second auxiliary electrode 207 is connected to the first auxiliary electrode 107 via lines 207a, 207b, at each pixel. That is, the second auxiliary electrodes 207 are formed within the slits 105a. In fact, the second auxiliary electrodes 207 are formed on portions on the substrate 102 located between the respective sub-pixel regions segmented by the slits 105a. Each of the second auxiliary electrodes 207 is placed at the corner portion of the sub-pixel region segmented by the slit 105a.

The first and second auxiliary electrodes 107, and 207 are formed at the process of forming the gate electrode and the gate line 108 of the TFT device 104, and, the second auxiliary electrodes 207 are formed on the locations corresponding to the first auxiliary electrode 107, the intersection point of the slits and the ends of those slits by patterning. The lines 207a, and 207b for connecting the first auxiliary electrode 107 and the second auxiliary electrode 207 are also formed in the same process by patterning.

Next, the behavior of the liquid crystal in the pixel with the above-described will be explained.

When a voltage is applied between the pixel electrode 105 and the opposing electrode 112 in the same fashion as the first embodiment, vertical electric fields are generated at a portion in each pixel where the pixel electrode 105 faces the opposing electrode 112, and horizontal electric fields are generated between the pixel electrode 105 and the auxiliary electrode 107. Regarding the portions of the pixel electrode 105 in which the slits 105a are formed, no vertical electric field is generated between both of the glass substrates, but electric fields in the directions oblique relative to the edges of the slits 105 are generated at the portions of the pixel electrode 105 in which the slits 105a are formed.

The second auxiliary electrodes 207 formed on the locations corresponding to the intersection point of the slits 105a and the ends of those slits are connected to the first auxiliary electrode 107 via the lines 207a, and 207b. Because the first auxiliary electrode 107 is connected to the opposing electrode 112 to set at the same electric potential as that of the opposing electrode 112, no electric field is generated at the liquid crystal layer of that regions which correspond to the second auxiliary electrodes 207, and the liquid crystal molecules are aligned perpendicular to the substrate.

As the horizontal electric fields are generated between the second auxiliary electrode 207 and the pixel electrode 105, the liquid crystal molecules around the second auxiliary electrode 207 is so aligned as to tilt from the region of the second auxiliary electrode 207 toward the periphery.

Accordingly, as illustrated in FIG. 9, the liquid crystal molecules of the pixel region corresponding to the pixel electrode 105 are aligned in such a way that the long axis directions (directors) thereof tilt toward the center of each sub-pixel region from the periphery, for each sub-pixel region divided by the slit 105a, due to the horizontal electric field by the first auxiliary electrode 107, the oblique electric fields at the edges of the slits 105a, and the horizontal electric fields around the second auxiliary electrodes 207. That is, because the forces attempting the liquid crystal molecules to tilt from the periphery of each sub-pixel region toward the center greatly act on the liquid crystal of each sub-pixel region, the center of the alignment for each pixel can be defined, and the liquid crystal molecules are radially aligned from that center, thereby stabilizing the alignment states.

As described above, the slits 105a extending toward the periphery of the pixel from the center of the pixel region are formed on the pixel electrode 105 to segment the pixel region into the plurality of sub-pixel regions. The first auxiliary electrode 107 is formed around the pixel electrode 105. The second auxiliary electrodes 207 are formed on the intersection portion of the slits 105a and the ends of those slits 105a. At the periphery portion of each segmented sub-pixel region, the liquid crystal molecules are aligned toward the center of the sub-pixel region from the periphery thereof, for each divided subpixel region, due to the electric fields generated in accordance with the voltage applied between the pixel electrode 105 and the first auxiliary electrode 107, and the electric fields generated between the pixel electrode 105 and the second auxiliary electrodes 107.

This results in the definition of the alignment of the liquid crystal molecules which is formed for each divided sub-pixel region. Accordingly, the display roughness and unevenness can be resolved. As the liquid crystal molecules are aligned toward the center of a domain for each sub pixel region, the view angle characteristic is improved.

The invention is not limited to the above embodiments, and can be adapted and modified as needed.

For example, the above embodiments may be combined with one another.

### Fourth Embodiment

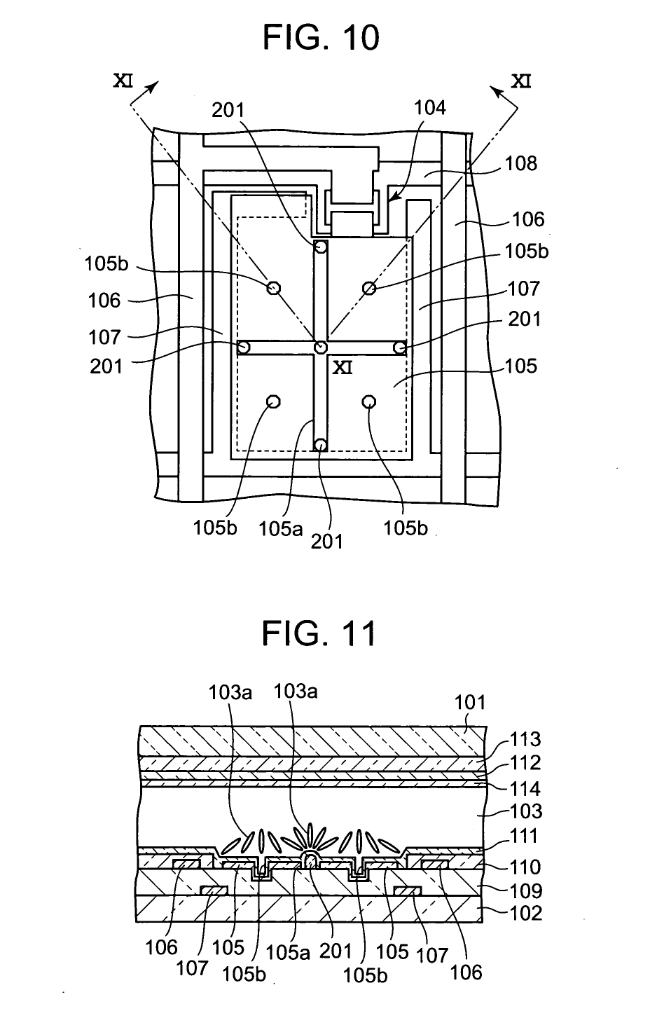

As illustrated in FIG. 10, the first embodiment and the second embodiment may be combined to form the recess portion 105b on the location corresponding to the center of each sub-pixel region of the pixel electrode 105 for each sub-pixel region segmented by the slits 105a, together with the protrusions 201 formed at the intersection portion of the slits 105a and the ends of those slits.

In this case, because of the actions of the recess portions 105b and the protrusions 201, the center of the alignment of the liquid crystal molecules of each sub-pixel region is defined by the recess portion 105b formed on the center of each sub-pixel region. Force for tilting the liquid crystal molecules toward the center of the sub-pixel region is applied from the periphery of the sub-pixel region by the slits 105a and the protrusions 201. Accordingly, for each sub-pixel region, the radial alignment with the recess portion being the center of the alignment can be stabilized. This results in further stabilization of the alignment states of the liquid crystal molecules formed for each sub-pixel region. Therefore, the display roughness and unevenness can be further resolved.

In the embodiments, although the auxiliary electrode 107 is made of a metal film like aluminum, the auxiliary electrode 107 may be formed by a transparent electrode which is constituted by a transparent conductive film like an ITO film.

In the embodiments, although the slits 105a are formed in the pixel electrode 105, the slits 105a may be formed on the opposing electrode 112. The slits may be formed on both of the pixel electrode 105 and the opposing electrode 112.

In the embodiments, the slits 105a are so formed as to extend along the vertical and horizontal directions from the center portion of the pixel electrode 105. However, the slits 105a are so placed as to segment the pixel electrode into regions with the approximately same shapes; for example, the slits 105a may be so formed along the diagonal lines as to extend from the center of the pixel toward the four corners. The number of the domains segmented by the slits 105a is not limited to four, and may be an arbitrary integer larger than or equal to two.

Various embodiments and changes may be made thereunto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2004-251696 filed on Aug. 31, 2004 and including specification, claims, drawings and summary. The disclosure of the above Japanese Patent Application is incorporated herein by reference in its entirety.

What is claimed is:

1. A liquid crystal display device comprising:
a first substrate provided with a first electrode;
a second substrate which is provided with at least one second electrode arranged opposite to the first electrode with a predetermined gap therebetween, and forms individual pixel regions by that region which faces the first electrode;
an auxiliary electrode formed on that surface of the second substrate on which the second electrode is provided, along at least a periphery of the pixel region;
a vertical alignment film formed on each of opposing inner surfaces of the first electrode and the second electrode;
a liquid crystal layer with a negative dielectric anisotropy filled between the substrates, wherein:
at least one of the first electrode and the second electrode is provided with an aperture for segmenting that pixel region into a plurality of sub-pixel regions for each pixel region; and
a step portion which aligns liquid crystal molecules of the liquid crystal layer in accordance with a shape of a film surface of the vertical alignment film, and is formed on at least one of a substantial center portion of each sub-pixel region, a corner portion of each segmented neighboring sub-pixel region, and a periphery portion of the pixel region of either the first substrate or the second substrate.

2. The liquid crystal display device according to claim 1, wherein the step portion is formed on the center portion of each sub-pixel region.

3. The liquid crystal display device according to claim 2, wherein the step portion is a recess portion.

4. The liquid crystal display device according to claim 1, wherein the step portion is formed in between the neighboring sub-pixel regions.

5. The liquid crystal display device according to claim 4, wherein the step portion is formed on the corner portion of the subpixel region for each sub-pixel region.

6. The liquid crystal display device according to claim 1, wherein the step portions are formed on the substantial center portion of each sub-pixel region and the periphery portion of the pixel region.

7. The liquid crystal display device according to claim 6, wherein the step portion comprises a recess portion which is formed on the center portion of the sub-pixel region, and a protrusion which forms a step in such a way that the circumference of the pixel region is higher than the pixel region.

8. A liquid crystal display device comprising:
a first substrate provided with a first electrode;
a second substrate provided with at least one second electrode arranged opposite to the first electrode with a predetermined gap therebetween, and forms individual pixel regions by that region which faces the first electrode;
an auxiliary electrode formed on that surface of the second substrate on which the second electrode is provided, along at least a periphery of the pixel region;
a vertical alignment film formed on each of opposing inner surfaces of the first electrode and the second electrode;
a liquid crystal layer with a negative dielectric anisotropy filled between the substrates;
a slit provided on at least the second electrode in the first and the second electrodes for segmenting the pixel region into a plurality of sub-pixel regions, and for aligning a molecular long axis of liquid crystal molecules of the liquid crystal layer from a periphery to a center for individual pixel regions, by an electric field applied between the second electrode and the auxiliary electrode; and
an alignment definition unit which forms a center or a base point of an alignment of the liquid crystal molecules of the liquid crystal layer on at least any one of a substantial center portion of each segmented sub-pixel region, a corner portion of each segmented neighboring sub-pixel region, or a periphery portion of the pixel region of that surface of the second electrode on which the second electrode is provided.

9. The liquid crystal display device according to claim 8, wherein the alignment definition unit comprises a recess portion or a protrusion which is formed on the substantial center portion of each sub-pixel region or in between the neighboring sub-pixel regions.

10. The liquid crystal display device according to claim 8, wherein the alignment definition unit comprises a recess portion formed on the substantial center portion of each sub-pixel region.

11. The liquid crystal display device according to claim 8, wherein the alignment definition unit comprises a protrusion which is formed on the corner portion of the sub-pixel region between the neighboring sub-pixel regions.

12. The liquid crystal display device according to claim 8, wherein the alignment definition unit comprises a recess portion which is formed on the substantial center portion of each sub-pixel region, and a protrusion which is formed in between the neighboring sub-pixel regions.

13. The liquid crystal display device according to claim 8, wherein the alignment definition unit comprises steps which are formed on the substantial center portion of each sub-pixel region and the periphery portion of the pixel region.

14. The liquid crystal display device according to claim 13, wherein the alignment definition unit comprises a recess portion which is formed on the substantial center portion of each sub-pixel region, and a protrusion which forms a step in such a way that the periphery portion of the pixel region is higher than the pixel region.

15. The liquid crystal display device according to claim 8, wherein the slit comprises a plurality of notches which are formed in such a manner as to extend from a center of each pixel region to a periphery thereof, and be connected to one another at a center portion of the pixel region.

16. The liquid crystal display device according to claim 8, wherein the auxiliary electrode is set to an electric potential equal to that of the first electrode opposite to the second electrode.

17. The liquid crystal display device according to claim 8, wherein the auxiliary electrode comprises a compensating-capacitor electrode which overlaps a periphery portion of the second electrode, and forms a compensating capacitor between the second electrode and the compensating-capacitor electrode.

18. A liquid crystal display device comprising:
a first substrate provided with a first electrode;
a second substrate provided with at least one second electrode arranged opposite to the first electrode with a predetermined gap therebetween, and forms individual pixel regions by that region which faces the first electrode;
a first auxiliary electrode formed on that surface of the second substrate on which the second electrode is provided, along at least a periphery of the pixel region;
a vertical alignment film formed on each of opposing inner surfaces of the first electrode and the second electrode;
a liquid crystal layer with a negative dielectric anisotropy filled between the substrates;
a slit provided on at least either the first electrode or the second electrode for segmenting the pixel region into a plurality of sub-pixel regions, and for aligning a molecular long axis of liquid crystal molecules of the liquid crystal layer from a periphery to a center for individual pixel regions, by an electric field applied between the second electrode and the auxiliary electrode; and
a second auxiliary electrode which is placed at a corner portion of each sub-pixel region between the segmented individual sub-pixel regions of that surface of the second substrate on which the second electrode is provided, and so formed as to be isolated from the second electrode.

19. The liquid crystal display device according to claim 18, wherein the second auxiliary electrode is connected to the first auxiliary electrode.

20. The liquid crystal display device according to claim 18, wherein the second auxiliary electrode comprises a transparent conductive film.
